(19) United States
(12) Patent Application Publication
(10) Pub. No.: US 2015/0268268 A1
(43) Pub. Date: Sep. 24, 2015

(54) INERTIAL SENSOR WITH TRIM CAPACITANCE AND METHOD OF TRIMMING OFFSET

(71) Applicant: FREESCALE SEMICONDUCTOR, INC., AUSTIN, TX (US)

(72) Inventors: Lianjun Liu, Chandler, AZ (US); Keith L. Kraver, Gilbert, AZ (US); Andrew C. McNeil, Chandler, AZ (US)

(21) Appl. No.: 13/919,638

(22) Filed: Jun. 17, 2013

(51) Int. Cl. G01P 15/125

(52) U.S. Cl. CPC G01P 15/125

(57) ABSTRACT

An inertial sensor (20) includes a movable element (24) coupled to a substrate (28) and adapted for motion about a rotational axis (34). The sensor (20) further includes a trim elements (36, 38). The trim elements (36, 38) are spaced away from a surface (26) of the substrate (28) and are symmetrically positioned on opposing sides of the rotational axis (34). The trim elements (36, 38) are largely insensitive to acceleration about the rotational axis (34), but are sensitive to asymmetrical bending of the substrate (28). Trim signals (72, 74) are received via the trim elements (36, 38) and sense signals (68, 70) are received via sense elements (50, 52). The trim signals (72, 74) are applied to the sense signals (68, 70) to trim an offset error in an output signal of the inertial sensor (20) to produce a compensated sense signal (144).

### TECHNICAL FIELD OF THE INVENTION

The present invention relates generally to microelectromechanical systems (MEMS) inertial sensors. More specifically, the present invention relates to an inertial sensor having built-in trim capacitance for trimming offset.

### BACKGROUND OF THE INVENTION

Microelectromechanical Systems (MEMS) devices are widely used in applications such as automotive, inertial guidance systems, household appliances, protection systems for a variety of devices, and many other industrial, scientific, and engineering systems. Such MEMS devices may be used to sense a physical condition such as acceleration, angular velocity, pressure, or temperature, and to provide an electrical signal representative of the sensed physical condition. MEMS sensor designs are highly desirable for operation in high gravity environments and in miniaturized devices, and due to their relatively low cost.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, the Figures are not necessarily drawn to scale, and:

FIG. 1 shows a top view of a microelectromechanical systems (MEMS) inertial sensor in accordance with an embodiment;

FIG. 2 shows a side schematic view of the inertial sensor of FIG. 1;

FIG. 3 shows a top view of an inertial sensor in accordance with another embodiment;

FIG. 4 shows a top view of an inertial sensor in accordance with yet another embodiment;

FIG. 5 shows a flowchart of an offset error trim process in accordance with an embodiment;

FIG. 6 shows a block diagram of the inertial sensor of FIG. 1 with a compensation circuit demonstrating the compensation of offset error in a sense signal in accordance with the offset error trim process of FIG. 5;

FIG. 7 shows a block diagram of the inertial sensor of FIG. 3 with a compensation circuit demonstrating the compensation of offset error in a sense signal in accordance with the offset error trim process of FIG. 5;

FIG. 8 shows a block diagram of the inertial sensor of FIG. 3 with a compensation circuit demonstrating the compensation of offset error in a sense signal in accordance with the offset error trim process of FIG. 5;

FIG. 9 shows a flowchart of a trim code definition process in accordance with another embodiment;

FIG. 10 shows a block diagram of the inertial sensor of FIG. 1 with a compensation circuit demonstrating the determination of trim codes in accordance with the trim code definition process of FIG. 9;

FIG. 11 shows a flowchart of an offset error trim process utilizing the trim codes of FIG. 10; and

FIG. 12 shows a block diagram of the inertial sensor of FIG. 1 with the compensation circuit of FIG. 10 demonstrating the compensation of offset error in a sense signal in accordance with the offset error trim process of FIG. 11.

### DETAILED DESCRIPTION

Capacitive-sensing MEMS inertial sensor designs are useful for measuring acceleration forces. These forces may be static, like the constant force of gravity, or they can be dynamic, caused by moving or vibrating the accelerometer. In general, capacitive-sensing MEMS accelerometers sense a change in electrical capacitance, with respect to acceleration, to vary the output of an energized circuit. One common form of accelerometer is a two layer capacitive inertial sensor having a “teeter-totter” or “see saw” configuration. This commonly utilized sensor type uses a movable element or plate that rotates under z-axis acceleration above a substrate. The accelerometer structure can measure two distinct capacitances to determine differential or relative capacitance.

In an accelerometer, when the movable element is not subject to acceleration, it should be in a non-excited state, i.e., a null state or position. For example, the movable element of a z-axis accelerometer should be balanced above a surface of an underlying substrate such that it lies generally in a plane that is parallel to the surface of the substrate. Unfortunately, displacement of the movable element from the non-excited state can result when the accelerometer is subjected to package stress or excessive temperature. For example, when a packaged accelerometer experiences a temperature change, the package substrate may bend due to a mismatch in the coefficient of thermal expansion (CTE) of the materials used to manufacture and package the accelerometer.

The term “offset” refers to the output deviation from its nominal value at the non-excited state of the MEMS sensor. Package stress and/or temperature induced displacement can produce a non-zero output electrical signal (i.e., an offset voltage) at the output terminals of the accelerometer in response to package stress or excessive temperature. Additionally, the offset voltage can vary from sensor to sensor due to process and manufacturing variations. Z-axis accelerometers are particularly subject to offset since they are more sensitive to asymmetrical bending of the underlying substrate. Unfortunately, offset of the movable element can result in decreased accelerometer performance, clipping, reduced usable dynamic range due to non-symmetry, and so forth.

Some architectures for MEMS accelerometers include capacitor banks that are connected to the sense nodes in order to trim for, i.e., adjust for, the offset. That is, in capacitive-sensing accelerometers, offset trimming is generally realized by transferring some amount of electric charge, Q, into the sense nodes of the accelerometer. Other techniques for offset trimming may be employed as well. For purposes of the following discussion, techniques used to adjust for offset in the movable element are referred to collectively as “trimming” or, alternatively, “offset trimming.”

Temperature coefficient of offset (TCO) is a measure of induced stresses as a function of temperature that are placed on a semiconductor device such as a MEMS device. Thus, TCO is a measure of how much thermal stresses effect the performance of a semiconductor device, such as a MEMS sensor. In MEMS accelerometer products, the TCO may be one of the most critical parameters and should be preferably near zero in order to reduce sensor inaccuracies. In practice, however, the TCO is typically not sufficiently near zero, thus requiring compensation to reduce the TCO to near zero.

For some accelerometer applications, offset trimming may be performed with the accelerometer at room temperature to derive a single offset value (electric charge) for a particular accelerometer. A single offset value may be inadequate for offset trimming over a wide range of operational temperatures and/or may not take into consideration the stress effect after the accelerometer is mounted to a board. While such an approach may be economical, part performance may be sacrificed.

In other accelerometer applications, TCO may be calculated using multiple temperature insertions. A correction factor offset trim value (sometimes referred to as a trim code) may then be derived for each temperature range. When in use, a temperature sensor can monitor the operating temperature of the accelerometer and the appropriate trim code corresponding to the current temperature may be applied in order to trim for, i.e., adjust for, the offset. Unfortunately, such a technique can significantly increase test costs. Furthermore, this approach may not take into consideration the stress effect after the accelerometer is mounted to a board.

Embodiments entail MEMS inertial sensor designs, which may be, for example, z-axis accelerometers or other sensing devices, that incorporate built-in trim elements that produce trim capacitances in response to asymmetrical bending of the underlying substrate for use in offset trimming. Embodiments additionally entail methodology for utilizing the built-in trim capacitors to perform a trim function using the measurements from the trim capacitors. The methodology can be used to perform dynamic, in situ compensation for the offset voltage or to determine the TCO correction factors (trim code). Such an approach can yield test cost savings as well as improved sensor performance.

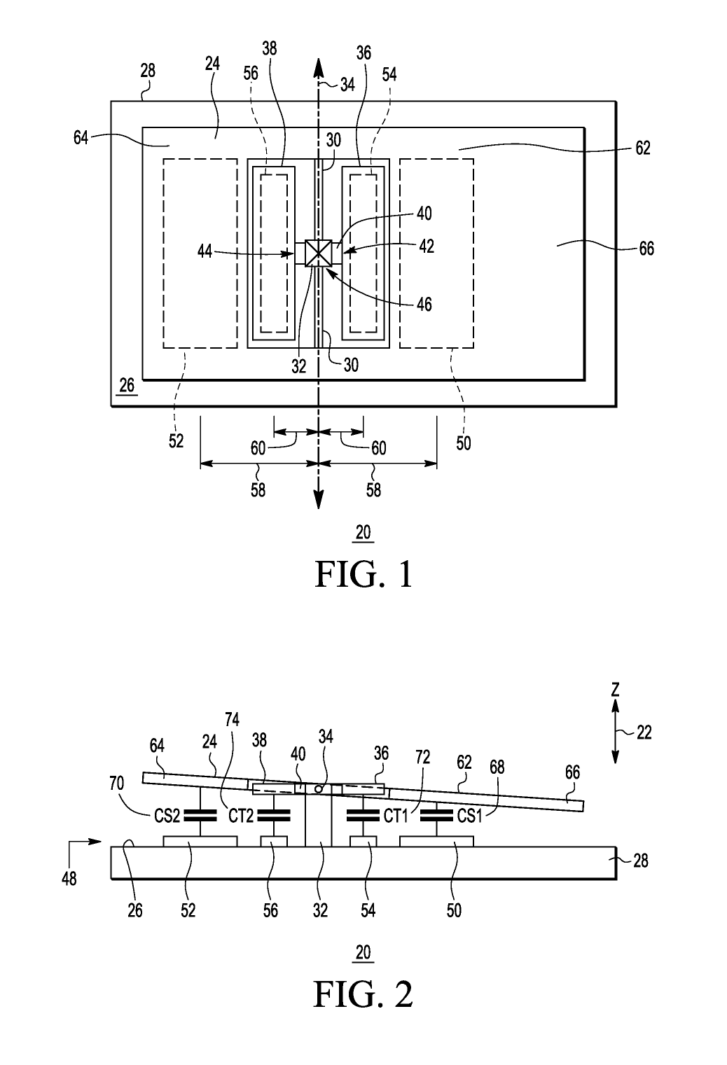

Referring to FIGS. 1 and 2, FIG. 1 shows a top view of a MEMS inertial sensor 20 in accordance with an embodiment and FIG. 2 shows a side schematic view of inertial sensor 20. In an embodiment MEMS inertial sensor 20 is a capacitive-sensing z-axis accelerometer that senses a change in electrical capacitance, with respect to acceleration in a Z-direction 22, to vary the output of an energized circuit (not shown).

MEMS sensor 20 includes a movable element 24, commonly referred to as a “proof mass” flexibly suspended above a surface 26 of a substrate 28 by one or more flexures 30. More particularly, MEMS inertial sensor 20 includes an anchor 32 formed on surface 26 of substrate 28, and flexures 30 are coupled between anchor 32 and movable element 24. Flexures 30 enable rotation of movable element 24 about a rotational axis 34, and anchor 32 is positioned at rotational axis 34. Anchor 32 is illustrated in FIG. 1 with an “X” overlying it to emphasize its fixed connection to the underlying substrate 28. It should be understood that a number of flexures, hinges, and other rotational mechanisms may be utilized to enable pivotal movement of movable element 24 about rotational axis 34.

MEMS sensor 20 further includes trim elements 36 and 38, respectively, spaced away from, i.e., suspended above, surface 26 of substrate 28 by a rigid beam structure 40. In the illustrated embodiment, trim elements 36 and 38, respectively, are immovably coupled to anchor 32, i.e. are static relative to anchor 32. In particular, an end 42 of beam structure 40 is affixed to trim element 36, the opposing end 44 of beam structure 40 is affixed to trim element 38, and a central region 46 of beam structure 40 is affixed to anchor 32. In some embodiments, beam structure 40 is suitably dimensioned to largely prevent movement of trim elements 36 and 38, respectively, about rotational axis 34 when MEMS sensor 20 is subjected to acceleration. Additionally, trim elements 36 and 38 are symmetrically positioned relative to one another on opposing sides of rotational axis 34.

A static conductive layer 48 is disposed on surface 26 of substrate 28. Static conductive layer 48 (most clearly seen in FIG. 2) is in the form of at least four electrically isolated electrodes or plates including, for example, sense elements 50 and 52, respectively, and trim elements 54 and 56, respectively. Sense elements 50 and 52 as well as trim elements 54 and 56 are visible in the side view diagram of FIG. 2. However, they are obscured by movable element 24 and trim elements 36 and 38 in the top view diagram of FIG. 1. Hence, in FIG. 1, they are represented in dashed line form.

Sense elements 50 and 52 are sized and spaced symmetrically with respect to rotational axis 34. That is, each of sense elements 50 and 52 is offset an equivalent distance 58 on opposing sides of rotational axis 34. Likewise, trim elements 54 and 56 are symmetrically arranged relative to rotational axis 34. That is, each of trim elements 54 and 56 is offset an equivalent distance 60 on opposing sides of rotational axis 34. Only two sense elements 50 and 52 are shown in FIGS. 1 and 2 for simplicity of illustration. However, in alternative embodiments, MEMS sensor 20 may include a different quantity and/or different configuration of electrode elements operating as excitation electrodes, sensing electrodes, and/or feedback electrodes.

When intended for operation as a teeter-totter type accelerometer, a section 62 of movable element 24 on one side of rotational axis 34 is formed with relatively greater mass than a section 64 of movable element 24 on the other side of rotational axis 34. In an embodiment, the greater mass of section 62 may be created by offsetting rotational axis 34 such that an extended portion 66 of section 62 is formed distal from rotational axis 34. In other embodiments, when rotational axis 34 is not offset, the greater mass of section 62 relative to section 64 may be created by making section 62 thicker than section 64, and/or by removing mass from section 64 by, for example, forming apertures extending through section 64.

The greater mass of section 62 causes movable element 24 to rotate/tilt about rotational axis 34 in response to acceleration in Z-direction 22, as demonstrated in FIG. 2. The movement of movable element 24 in Z-direction 22 is sensed by sense elements 50 and 52, which are disposed on surface 26 of substrate 28 beneath movable element 24. FIG. 2 further demonstrates that when movable element 24 rotates/tilts about rotational axis 34 in response to acceleration, trim elements 36 and 38, respectively, coupled to anchor 32 via rigid beam 40 do not rotate/tilt about rotational axis 34, Instead, trim elements 36 and 38, respectively, may move symmetrically under acceleration due to their symmetrical location on opposing sides of rotational axis 34. As such, trim element 36 and 38 are not sensitive to acceleration (differentially) due to the design symmetry but are instead only sensitive to asymmetrical bending of substrate 28 (under stress or temperature).

In an embodiment, sense element 50 faces section 62 of movable element 24, and thus a sense signal, referred to herein as a sense capacitance 68 and labeled CS1, is produced between sense element 50 and section 62 of movable element 24. Similarly, sense element 52 faces section 64 of movable element 24, and thus a sense signal, referred to herein as a sense capacitance 70 and labeled CS2, is produced between sense element 52 and section 64 of movable element 24. The change of position of movable element 24 relative to the static sense elements 50 and 52 in response to acceleration in Z-direction 22 results in sense capacitances 68 and 70, respectively, whose difference, i.e., a differential capacitance, is indicative of acceleration in Z-direction 22. It should be understood that the capacitor symbols illustrated in FIG. 2 do not represent physical capacitors. Rather, the capacitor symbols represent the capacitance signals between the elements formed on substrate 28 and the overlying suspended elements of MEMS sensor 20.

Detection circuitry (not shown) captures a resulting capacitance signal generated from sense capacitances 68 and 70 which is subsequently processed to a final output signal. When subject to a fixed or constant acceleration, the capacitance value is also constant, resulting in a measurement signal proportional to static acceleration, also referred to as DC or uniform acceleration, which can subsequently be processed to a final output signal.

During operation the sense signal, i.e., the final output signal, may include an offset signal component resulting from the indirect coupling of movable element 24 to the underlying substrate 28 via anchor 32. Thus, deformation of the underlying substrate due to, for example, package stress and/or temperature variation can produce a non-zero output electrical signal (e.g., an offset voltage) at the output terminals of the accelerometer. Trim elements 36, 38, 54, and 56 are implemented in inertial sensor 20 to compensate for, i.e., largely cancel, this offset voltage.

It should be recalled that trim elements 36 and 38, respectively are indirectly attached to the underlying substrate 28 via anchor 32. Thus, trim elements 36 and 38 will experience the same or nearly the same offset as does movable element 24. In an embodiment, trim element 54 faces trim element 36. Thus, a trim signal, referred to herein as a trim capacitance 72 and labeled CT1, is produced between trim element 36 and trim element 54. Similarly, trim element 56 faces trim element 38. Thus, a trim signal, referred to herein as a trim capacitance 74 and labeled CT2, is produced between trim element 38 and trim element 56.

A resulting capacitance signal generated from trim capacitances 72 and 74 is produced when trim elements 36 and 38 are under package stress and/or elevated temperature. Moreover, the difference between trim capacitances 72 and 74, respectively, correlates with the difference between sense capacitances 68 and 70, respectively under package stress and/or elevated temperature. However, since trim capacitances 72 and 74 are immovable about rotational axis 34, trim capacitances 72 and 74 should have no or minimum change (differentially) under acceleration. As will be discussed in connection with methodology presented below, trim capacitances 72 and 74 can be used to trim an offset error component in an output signal of inertial sensor 20.

Inertial sensor 20 may be fabricated in accordance with conventional MEMS process technologies, such as, for example, surface micromachining using a number of different conductive, semi-conductive, and/or dielectric materials. Surface micromachining is based on the deposition, patterning, and etching of different structural layers. Surface micromachining enables the fabrication of high-quality MEMS devices because it is based on thin-film technology that combines control and flexibility in fabrication. By way of example, surface 26 of substrate 28 may be deposited with conductive material layer 48. This conductive material layer 48 can then be masked, patterned, and etched to define sense elements 50 and 52, respectively, and trim elements 54 and 56, respectively. Subsequent operations can entail the deposition of a sacrificial layer, formation of contact openings, deposition of a second conductive material, masking, patterning, etching, and the like per conventional techniques to produce inertial sensor 20 having movable element 24 and the suspended and immovable trim elements 36 and 38, respectively.

In the configuration of FIG. 1, a single anchor 32 is formed from which movable element 24 and trim elements 36 and 38 are suspended. In such a structural configuration, movable element 24 and trim elements 36 and 38 may be readily shorted together, i.e., electrically connected, so that movable element 24 and trim elements 36 and 38 form a common node, or terminal. Thus, each of sense elements 50 and 52, and trim elements 54 and 56 are electrically isolated to yield sense capacitance 68, sense capacitance 70, trim capacitance 72 and trim capacitance 74. In alternative embodiments, however, movable element 24 and trim elements 36 and 38 may be electrically isolated from one another.

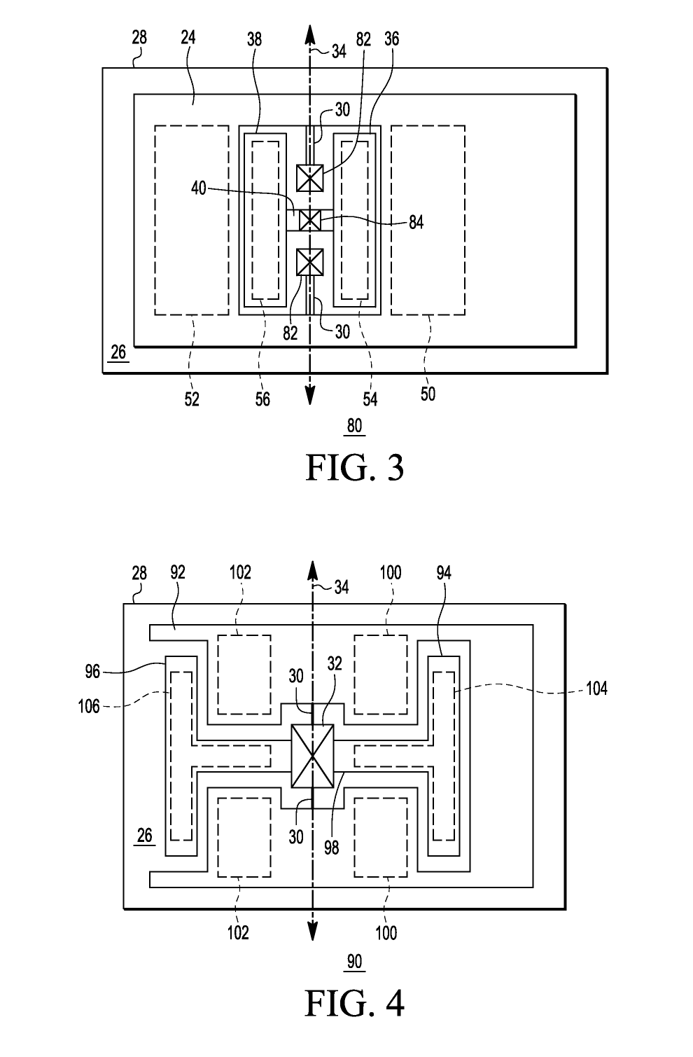

FIG. 3 shows a top view of an inertial sensor 80 in accordance with another embodiment. Inertial sensor 80 is similar to inertial sensor 20. Thus, the same reference numerals for the same components will be utilized to in the following discussion of inertial sensor 80, with new reference numerals being assigned to those elements that are unique to inertial sensor 80. Accordingly, inertial sensor 80 includes movable element 24 flexibly suspended above surface 26 of substrate 28 by flexures 30, and trim elements 36 and 38, respectively, spaced away from, i.e., suspended above, surface 26 of substrate 28 by rigid beam structure 40. Inertial sensor 80 further includes sense elements 50 and 52, respectively, and trim elements 54 and 56, as discussed in detail above.

In contrast to inertial sensor 20 (FIG. 1), inertial sensor 80 includes at least one anchor 82 (two anchors 82 illustrated herein) formed on surface 26 of substrate 28 and flexures 30 are coupled between anchors 82 and movable element 24. Additionally, a separate anchor 84 is formed on surface 26 of substrate 28 and trim elements 36 and 38, respectively, are immovably coupled to this separate anchor 84 via rigid beam structure 40. Each of anchors 82 and 84 are positioned at rotational axis 34, i.e., the axis of symmetry for trim elements 36 and 38.

In the configuration of FIG. 3, separate anchors are formed from which movable element 24 and trim elements 36 and 38 are suspended. That is, movable element 24 is flexibly suspended from proof mass anchors 82 via flexures 30, and movable element 24 is adapted to rotate/tilt about rotational axis 34 in response to acceleration in Z-direction 22 (FIG. 2). However, trim elements 36 and 28 are suspended from a trim element anchor 84 via rigid beam structure 40 and are thus immovable relative to rotational axis 34. In such a structural configuration, the common nodes, or terminals, of the movable element 24 and trim elements 36 and 38 may be electrically isolated from one another due to their separate connections to the underlying substrate 28. However, in alternative embodiments, the common nodes of movable element 24 and trim elements 36 and 38 may be shorted together, i.e., electrically connected.

Although separate anchors 82 and 84 are used to suitably suspend movable element 24 and trim elements 36 and 38 above the underlying substrate 28, due to their position at rotational axis 34, each of movable element 24 and trim elements 36 and 38 will be subject to similar offset error due to package stress and temperature variation. Thus, any offset error imposed on the sense signal can be compensated for, i.e., corrected, as will be discussed in connection with methodology presented below.

Both inertial sensor 20 (FIG. 1) and inertial sensor 80 provide examples in which trim elements 54 and 56 are located closer to rotational axis 34 than sense elements 50 and 52, respectively. In alternative embodiments, it may be useful to reverse the positions of trim elements 54, 56 with sense elements 50, 52 so that sense elements 50 and 52 are closer to rotational axis 34 than trim elements 54 and 56.

FIG. 4 shows a top view of an inertial sensor 90 in accordance with yet another embodiment. Inertial sensor 90 is similar to inertial sensors 20 and 80. Thus, the same reference numerals for the same components will be utilized to in the following discussion of inertial sensor 90, with new reference numerals being assigned to those elements that are unique to inertial sensor 90. Accordingly, inertial sensor 90 includes a movable element 92 flexibly suspended above surface 26 of substrate 28 by flexures 30, and trim elements 94 and 96, respectively, spaced away from, i.e., suspended above, surface 26 of substrate 28 by an elongated rigid beam structure 98. Like inertial sensor 20, inertial sensor 90 also includes a single anchor 32 formed on surface 26 of substrate 28, where flexures 30 are coupled between anchor 32 and movable element 92 and rigid beam structure 98 is coupled to anchor 32. Inertial sensor 90 further includes sense elements 100 and 102, respectively, and trim elements 104 and 106 disposed on the underlying substrate 28.

In contrast to inertial sensors 20 (FIG. 1) and 80 (FIG. 3), inertial sensor 90 provides an example in which sense elements 100 and 102 are closer to rotational axis 34 than trim element 94 and 96, and consequently, their associated trim elements 104 and 106, respectively. The structural configuration of FIG. 3 may result in trim elements 94 and 96 being more sensitive to deformation of the underlying substrate 28 (relative to the trim elements of inertial sensors 20 and 80) since they are located farther from rotational axis 34, therefore better able to compensate for offset error.

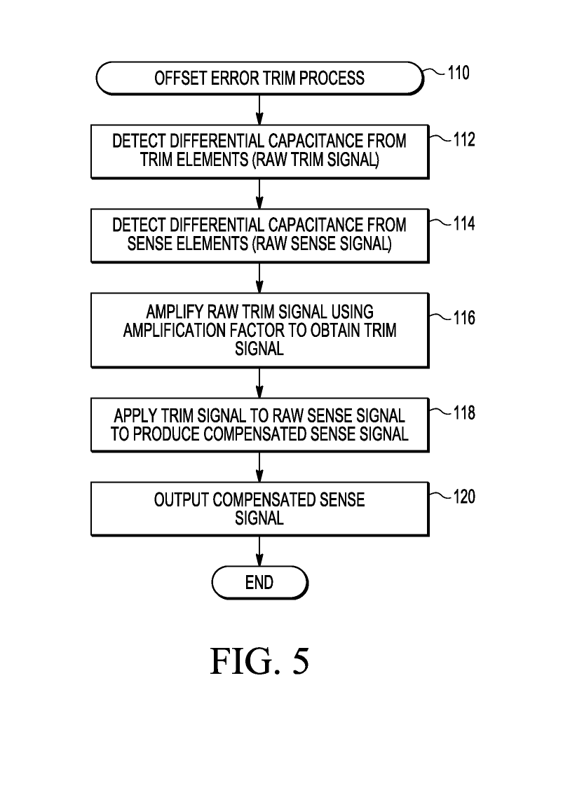

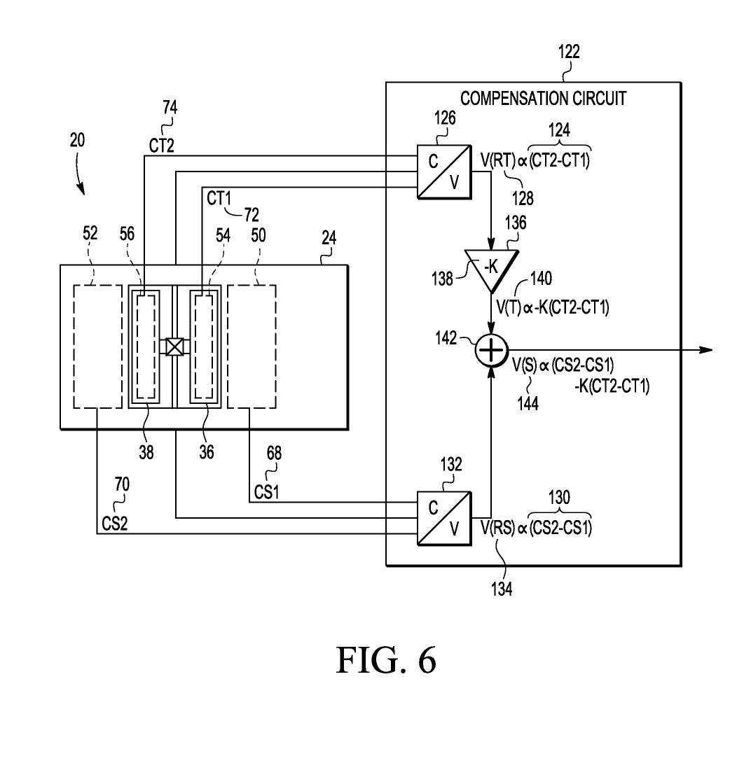

FIG. 5 shows a flowchart of an offset error trim process 110 in accordance with an embodiment. Offset error trim process 110 may be executed in conjunction with any of inertial sensors 20 (FIG. 1), 80 (FIG. 3), and 90 (FIG. 4) to perform dynamic, in situ correction of offset error. In other words, offset error trim process 110 is performed when the inertial sensor is in operational use in an end application. FIG. 5 provides general methodology for performing dynamic, in situ correction. Subsequent FIGS. 6-8 (discussed below) provide block diagrams demonstrating the methodology of FIG. 5.

Offset error trim process 110 begins with a task 112. At task 112, a differential trim capacitance is detected from the trim elements. Referring briefly to FIG. 2, trim capacitances 72 and 74 from trim elements 36, 38, 54, and 56 are received at a compensation circuit (not shown). The difference between trim capacitances 72 and 74 is the differential trim capacitance, and will be referred to herein as the raw trim signal.

A task 114 is performed in connection with task 112. At task 114, a differential sense capacitance is detected from the sense elements. Again referring briefly to FIG. 2, sense capacitances 68 and 70 from sense elements 50 and 52 and movable element 24 are received at the compensation circuit. The difference between sense capacitances 68 and 70 is the differential sense capacitance, and will be referred to herein as the raw sense signal.

Offset error trim process 110 continues with a task 116. At task 116, the raw trim signal detected at task 112 may be amplified using a trim signal amplification factor. In some embodiments, it may be desirable to electronically amplify the capacitance change of the trim elements, i.e., the raw trim signal, and use the amplified signal to dynamically trim the offset error from the differential sense capacitance. Accordingly, in some embodiments, prior to factory test and/or in situ operation of the inertial sensor, e.g., any of inertial sensors 20 (FIG. 1), 80 (FIG. 3), and 90 (FIG. 4), the trim signal amplification factor may be determined. The determination of the trim signal amplification factor may be done through characterization of several lots of the inertial sensor of interest. At task 116, amplification of the raw trim signal may be performed by multiplying the raw trim signal by the trim signal amplification factor to obtain the trim signal. In some embodiments, task 116 is not performed when amplification is not needed. In such a case, the raw trim signal will be the trim signal.

Once the trim signal is obtained at task 116, a task 118 is performed. At task 118, the trim signal is applied to the raw sense signal determined at task 114 to produce a compensated sense signal in which offset error due to package stress and temperature has been largely removed. In some embodiments, the trim signal is subtracted from the raw sense signal to produce the compensated sense signal.

Process 110 continues with a task 120. At task 120, this compensated sense signal, indicative of acceleration, and corrected for offset error is output from the compensation circuit (not shown). Following task 120, an iteration of offset error trim process 110 ends. Of course, in some embodiments, process 110 is continuously repeated in order to obtain continuous or periodic acceleration readings in accordance with particular design configurations.

FIG. 6 shows a block diagram of inertial sensor 20 with a compensation circuit 122 demonstrating the compensation of offset error in a sense signal in accordance with offset error trim process 110 (FIG. 5). As shown in FIG. 6, a differential trim capacitance 124 is detected in accordance with task 112 (FIG. 5) as the difference between trim signal 74 and trim signal 72. Differential trim capacitance 124 is input into a capacitance-to-voltage block 126 which conditions differential trim capacitance 124 to produce a raw trim voltage signal 128, labeled V(RT), that is proportional to differential trim capacitance 124. Similarly, a differential sense capacitance 130 is detected in accordance with task 114 (FIG. 5) as the difference between sense signal 70 and sense signal 68. Differential sense capacitance 130 is input into another capacitance-to-voltage block 132 which conditions differential sense capacitance 130 to produce a raw sense voltage signal 134, labeled V(RS) that is proportional to differential sense capacitance 130.

Raw trim voltage signal 128 is amplified at a gain block 136 using an amplification factor 138, labeled -K, to obtain a trim signal 140, labeled V(T), in accordance with task 116 (FIG. 5). Trim signal 140 is applied to raw sense voltage signal 134 via a summing circuit 142 in accordance with task 118 (FIG. 5) to yield a compensated sense voltage signal 144, labeled V(S), that is proportional to the difference between raw sense voltage signal 134 and trim signal 140. Using independent capacitance-to-voltage blocks 126 and 132, raw sense voltage signal 134 can be continually compensated to remove the offset error, measured as raw trim voltage signal 128 and suitably amplified to produce trim signal 140.

Compensation circuit 122 may be implemented in hardware, software, or some combination thereof. Additionally, gain block 136 and/or summing circuit 142 may be implemented in an analog domain, or alternatively, in the digital domain. The block diagram of FIG. 6 applies to a scenario in which the sense capacitors and the trim capacitors have a common node, i.e., trim elements 36 and 38 and movable element 24 are electrically connected at anchor 32. In alternative embodiments, compensation circuit 122 may be implemented when the common terminals for the sense capacitors are electrically isolated from the common terminals for the trim capacitors.

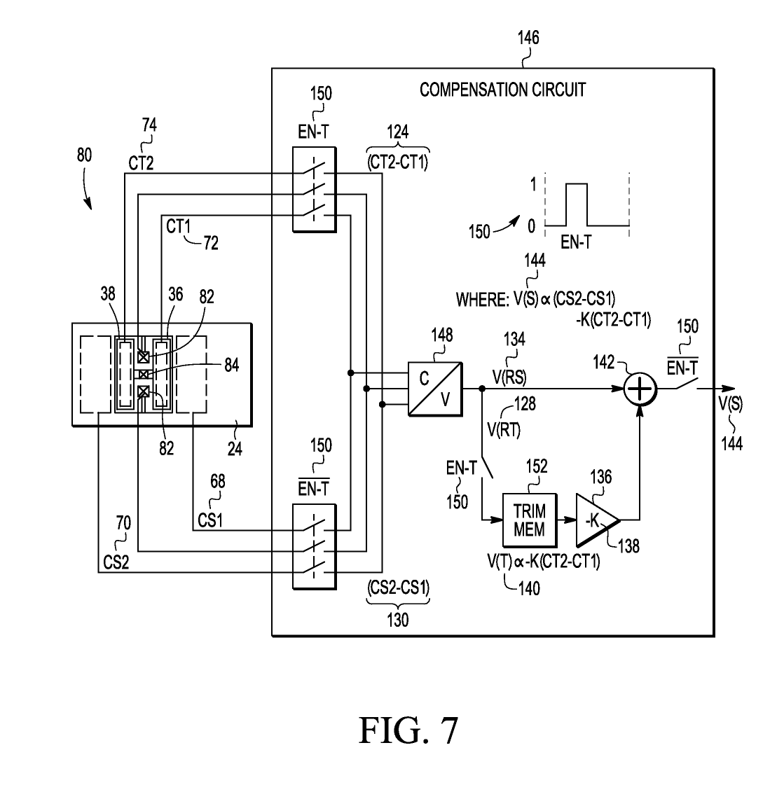

FIG. 7 shows a block diagram of inertial sensor 80 with a compensation circuit 146 demonstrating the compensation of offset error in a sense signal in accordance with offset error trim process 110 (FIG. 5). Differential trim capacitance 124 is detected in accordance with task 112 (FIG. 5) as the difference between trim signal 74 and trim signal 72 and differential sense capacitance 130 is detected in accordance with task 114 (FIG. 5) as the difference between sense signal 70 and sense signal 68.

The configuration shown in FIG. 7 represents a time interleaved system having a single capacitance-to-voltage block 148. At a given time period, a logic signal 150, labeled EN-T, controls whether capacitance-to-voltage block 148 is processing differential trim capacitance 124 to obtain raw trim voltage signal 128 or differential sense capacitance 130 to obtain raw sense voltage signal 134. The required duty cycle of logic signal 150 depends upon the application and could be programmable. Alternatively, the trim cycle could be performed on demand from a host system (not shown) which could set logic signal 150.

In an example, when the trim cycle is set, i.e., logic signal 150 is set to, for example “1,” raw trim voltage signal 128 may be stored in a trim storage block 152, labeled TRIM MEM, and/or raw trim voltage signal 128 may be amplified at gain block 136 using amplification factor 138 to obtain trim signal 140. Trim signal 140 can eventually be applied to raw sense voltage signal 134 via summing circuit 142 in accordance with task 118 (FIG. 5) to yield compensated sense voltage signal 144 that is proportional to the difference between raw sense voltage signal 134 and trim signal 140.

In various embodiments, trim storage block 152, gain block 136 and/or summing circuit 142 of compensation circuit 146 may be implemented in the analog domain, or alternatively, in the digital domain. The block diagram of FIG. 7 applies to a scenario in which the common nodes, or terminals, of the sense capacitors and the trim capacitors are electrically isolated from one another. That is, the common terminal for trim elements 36 and 38 may be trim element anchor 84, and the common terminal for movable element 24 may be proof mass anchors 82. In alternative embodiments, however, the common terminal for the sense capacitors may be electrically connected with the common terminal for the trim capacitors, as in the configuration shown in FIG. 1.

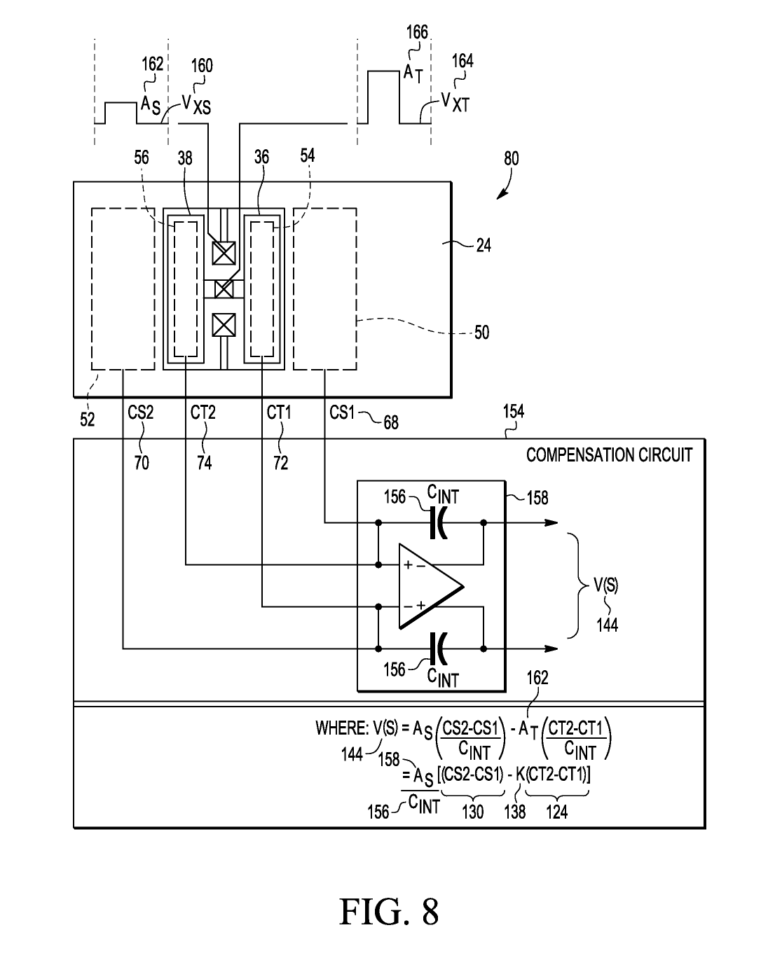

FIG. 8 shows a block diagram of inertial sensor 80 with a compensation circuit 154 demonstrating the compensation of offset error in a sense signal in accordance with offset error trim process 110 (FIG. 5). Differential trim capacitance 124 is detected in accordance with task 112 (FIG. 5) as the difference between trim signal 74 and trim signal 72 and differential sense capacitance 130 is detected in accordance with task 114 (FIG. 5) as the difference between sense signal 70 and sense signal 68.

The configuration shown in FIG. 8 represents a system having a driven movable element 24, at least one feedback capacitor 156, labeled C_{INT}, and a single capacitance-to-voltage block 158 to provide continuous compensation (charge summing), i.e., to obtain compensated sense voltage signal 144. Additionally, the compensation is performed early in the signal chain, which reduces the chance of overloading the circuits before the correction is applied. In this embodiment, the common node of the sense capacitors, i.e., movable element 24, is driven with a periodic excitation sense voltage waveform 160, labeled V_{XS}, at an amplitude 162, labeled A_{S}, and the common node of the trim capacitors, i.e., trim elements 36 and 38, is driven with a periodic excitation trim voltage waveform 164, labeled V_{XT}, at an amplitude 166, labeled A_{T}. Gain of the contribution of the trim capacitors may be accomplished by setting amplitude 162 of sense voltage waveform 160 for the sense capacitors to be less than amplitude 166 of trim voltage waveform 164 for the trim capacitors. Thus, amplification factor 138, K, is equivalent to A_{T}/A_{S}.

The block diagram of FIG. 8 applies to a scenario in which the common terminals of the sense capacitors and the trim capacitors are electrically isolated from one another. However, in alternative embodiments, the common terminals can be electrically connected, i.e., shorted, and the excitation waveforms 160 and 164 applied to the split nodes where excitation voltage 160 is applied to sense elements 50 and 52 and excitation voltage 164 is applied to trim elements 54 and 56.

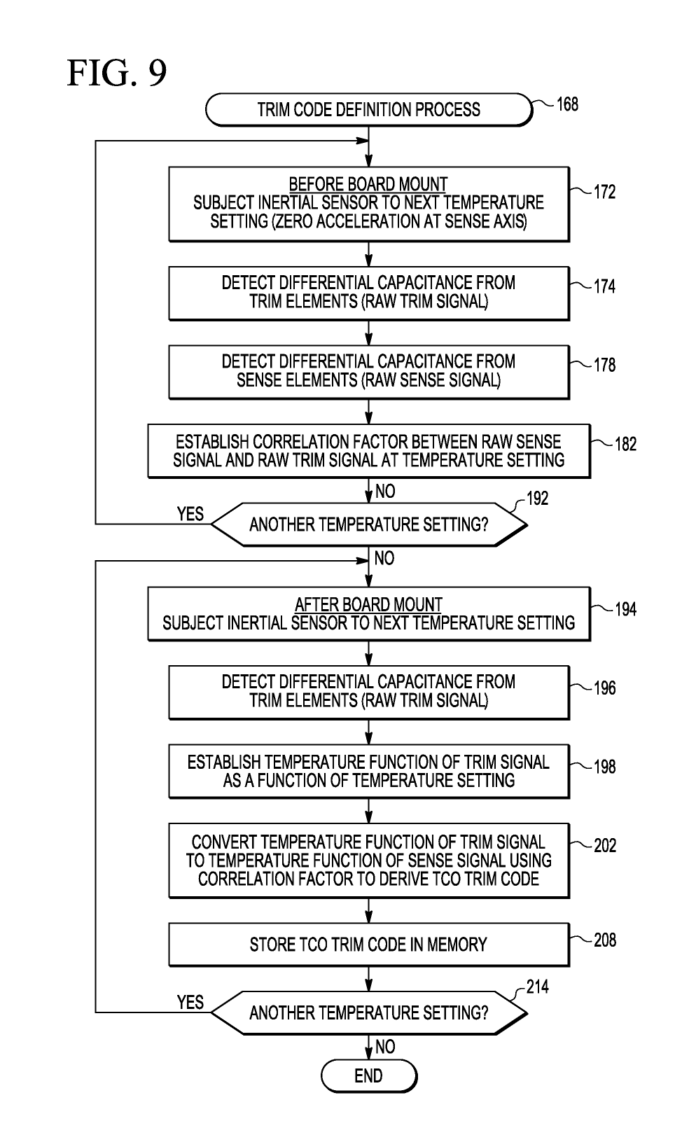

Offset error trim process 110 (FIG. 5) may be executed to perform dynamic correction of offset error when the inertial sensor is in operational use in an end application. In some embodiments, the trim structure of the inertial sensors, discussed above, may be utilized to obtain a Temperature Coefficient of Offset (TCO) trim code following board mount. This methodology can result in a more accurate TCO trim code than current techniques in which the TCO trim code is determined prior to board mount. That is, current techniques for determining the TCO trim code may not adequately take into consideration the stress effect after board mount. The following discussion of FIGS. 9-12 demonstrates the utilization of the trim structure of the inertial sensors to define the TCO trim code and to utilize the TCO trim code to correct for offset error.

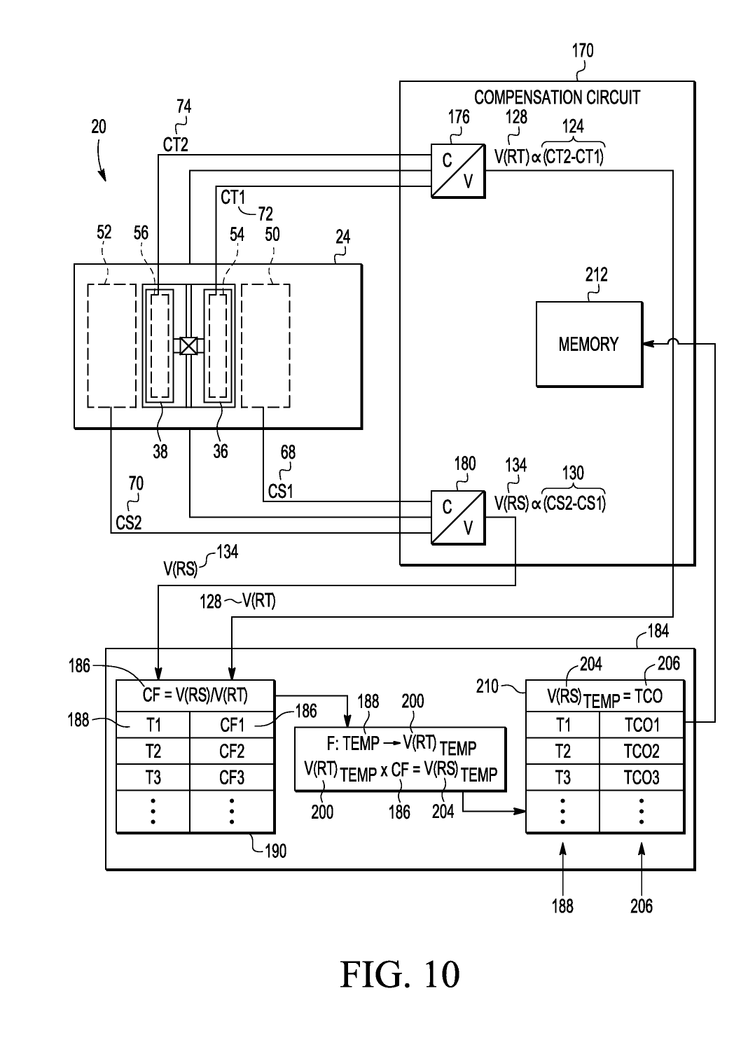

Referring to FIGS. 9-10, FIG. 9 shows a flowchart of a trim code definition process 168 in accordance with another embodiment, and FIG. 10 shows a block diagram of inertial sensor 20 with a compensation circuit 170 demonstrating the determination of trim codes in accordance with trim code definition process 168. Although the following processes are discussed in connection with correcting offset error in inertial sensor 20, it should be understood that the following processes may additionally be executed to correct offset error in inertial sensor 80 (FIG. 3) and/or inertial sensor 90 (FIG. 4).

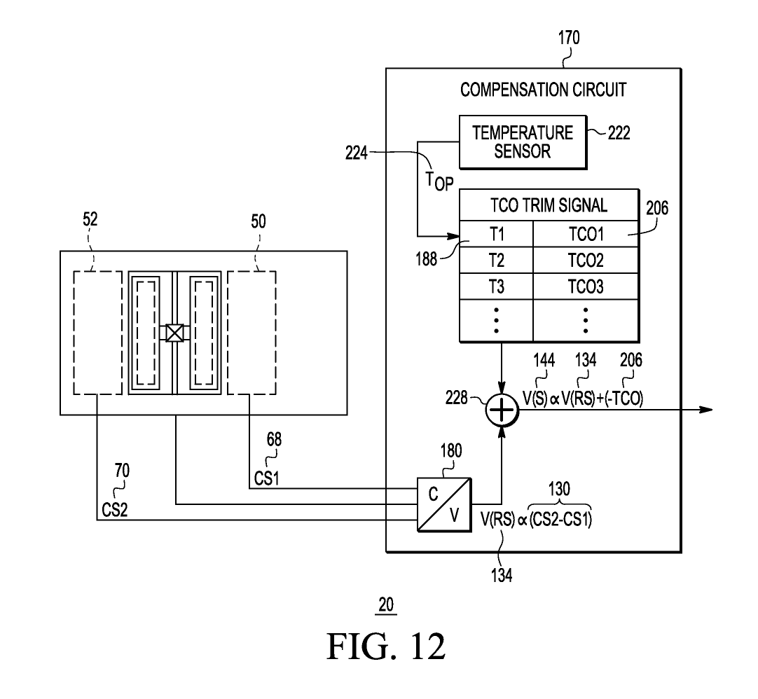

Trim code definition process 168 includes a series of operations that may be executed prior to board mount of inertial sensor 20. Trim code definition process 168 then continues with a series of operations that may be executed after board mount of inertial sensor 20. Compensation circuit 170 presented in FIG. 10 is only illustrated to include a few elements that may be utilized to perform trim code definition process 168. Compensation circuit 170 may include additional elements that will be discussed in greater detail in connection with FIG. 12.

Trim code definition process 168 begins with a task 172. At task 172, inertial sensor 20 is subjected to a next temperature setting. Of course, during a first iteration of trim code definition process 168, a “next” temperature setting may be a first temperature setting. Task 172 is performed prior to board mount of inertial sensor 20 and under zero acceleration at the sensing axis.

In response to task 172, a task 174 is performed. At task 174, a differential trim capacitance is detected from the trim elements. In particular, trim capacitances 72 and 74 from trim elements 54 and 56 are received at compensation circuit 170. The difference between trim capacitance 74 and trim capacitance 72 is differential trim capacitance 124. Differential trim capacitance 124 is input into a capacitance-to-voltage block 176 which conditions differential trim capacitance 124 to produce a raw trim voltage signal 128, labeled V(RT), that is proportional to differential trim capacitance 124.

A task 178 is performed in connection with task 174. At task 178, a differential sense capacitance is detected from the sense elements. In particular, sense capacitances 68 and 70 from sense elements 50 and 52 are received at compensation circuit 170. The difference between sense capacitance 70 and sense capacitance 68 is differential sense capacitance 130. Differential sense capacitance 130 is input into another capacitance-to-voltage block 180 which conditions differential sense capacitance 130 to produce raw sense voltage signal 134, labeled V(RS), that is proportional to differential sense capacitance 130.

Trim code definition process 168 continues with a task 182. At task 182, a correlation factor is established between raw sense voltage signal 134 and raw trim voltage signal 128. By way of example, the block diagram of FIG. 10 includes a processing block 184 for executing the various tasks of trim code definition process 168. As shown, raw sense voltage signal 134 and raw trim voltage signal 128 are input into processing block 184 and a correlation factor 186, labeled CF, is represented as a quotient of raw sense voltage signal 134 divided by raw trim signal 128. Of course, other mathematical techniques may be implemented to determine correlation factor 186. After correlation factor 186 is determined for a particular temperature setting 188, correlation factor 186 is at least temporarily saved in association with temperature setting 188, as represented in a table 190 included for exemplary purposes in processing block 184.

Following task 182, trim code definition process 168 continues with a query task 192. At query task 192, a determination is made as to whether there is another temperature setting 188 at which a correlation factor 186 is to be established. If there is another temperature setting 188, process control loops back to task 172 so that correlation factors 186 can be determined at multiple temperature settings 188. However, when a determination is made at query task 192 that there are no further temperature settings 188 for which correlation factor 186 is to be established, trim code definition process 168 continues with a task 194.

Task 194 is executed after a correlation factor 186 is established for each temperature setting 188 of interest. Additionally, task 194 is executed after inertial sensor 20 has been board mounted. Thus, task 194 and subsequent tasks of trim code definition process can be executed to derive a TCO trim code, taking into consideration stress due to board mounting. At task 194, inertial sensor 20 is subjected to a next temperature setting. Again, during a first iteration of task 194, the “next” temperature setting may be a first temperature setting. During the execution of task 194, there is not a zero acceleration requirement.

Process 168 continues with a task 196. At task 196, a differential trim capacitance is detected from the trim elements. Again, trim capacitances 72 and 74 from trim elements 54 and 56 are received at compensation circuit 170. The difference between trim capacitance 74 and trim capacitance 72, i.e., differential trim capacitance 124 is input into a capacitance-to-voltage block 176 which conditions differential trim capacitance 124 to produce a raw trim voltage signal 128, labeled V(RT), that is proportional to differential trim capacitance 124.

A task 198 is performed in connection with task 196. At task 198, a temperature function of raw trim voltage signal 128 is established as a function of temperature setting 188. By way of example, processing block 184 includes a functional representation which shows a trim voltage signal 200, labeled V(RT)_{TEMP}, as a function of temperature setting 188. Those skilled in the art will recognize that various mathematical techniques may be implemented to determine trim voltage signal 200.

Following task 198, a task 202 is performed. At task 202, the temperature function of the raw trim voltage signal 128, i.e., trim voltage signal 200, is converted to a temperature function of a sense signal using the correlation factor to derive the trim code. By way of example, processing block 184 includes a mathematical representation which shows the conversion of trim voltage signal 200 to a sense voltage signal 204, labeled V(RS)_{TEMP}, using correction factor 186 for a particular temperature setting 188. In an embodiment sense voltage signal 204 determined using correction factor 186 is a derived TCO trim code 206.

Trim code definition process 168 continues with a task 208. At task 208, TCO trim code 206 is stored in memory. By way of example, processing block 184 includes a table 210. Table 210 includes multiple temperature settings 188 and TCO trim codes 206, where each temperature setting 188 has a particular TCO trim code 206 associated therewith. Table 210 may be memory that at least temporarily stores TCO trim codes 206 in association with their temperature settings 188. The contents of table 210 may subsequently be loaded into a corresponding memory element 212 in compensation circuit 170, so that TCO trim codes 206 can be accessed when inertial sensor 20 is in operational use. Although only a single inertial sensor 20 is represented herein, the contents of table 210 may be loaded into the corresponding memory elements 212 of a plurality of inertial sensors 20 so that each inertial sensor has the same TCO trim codes 206.

Following task 208, trim code definition process 168 continues with a query task 214. At query task 214, a determination is made as to whether there is another temperature setting for which TCO trim code 206 is to be determined. When there is another temperature setting, program control loops back to task 194 to repeat the determination of TCO trim code 206 at another temperature setting 188. However, if there is not another temperature setting for which TCO trim code 206 is to be determined, trim code definition process 168 exits.

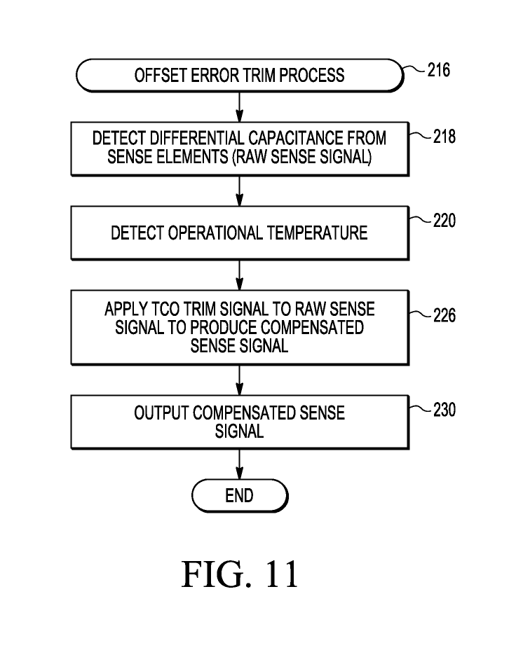

Referring to FIGS. 11 and 12, FIG. 11 shows a flowchart of an offset error trim process 216 utilizing TCO trim codes 206 (FIG. 10), and FIG. 12 shows a block diagram of inertial sensor 20 with compensation circuit 170 demonstrating the compensation of offset error in a sense signal in accordance with offset error trim process 216. Offset error trim process 216 represents methodology in one of TCO trim codes 206 stored in memory element 212 is used to correct sensor offset. Again, compensation circuit 170 presented in FIG. 12 is only illustrated to include a few elements that may be utilized to perform offset error trim process 216 for simplicity of illustration.

Offset error trim process 216 begins with a task 218. At task 218, a differential sense capacitance is detected from the sense elements in response to acceleration in Z-direction 22 (FIG. 2). In particular, sense capacitances 68 and 70 from sense elements 50 and 52 are received at compensation circuit 170. The difference between sense capacitance 70 and sense capacitance 68 is differential sense capacitance 130. Differential sense capacitance 130 is input into capacitance-to-voltage block 180 which conditions differential sense capacitance 130 to produce raw sense voltage signal 134, labeled V(RS), that is proportional to differential sense capacitance 130.

A task 220 is performed in cooperation with task 218. At task 220, the operational temperature of inertial sensor 20 is detected. As shown in FIG. 12, compensation circuit 170 can include a temperature sensor 222. Temperature sensor 222 outputs an operational temperature 224 indicating the temperature at which inertial sensor 20 is currently being subjected.

In response to tasks 218 and 220, a task 226 is performed. At task 226, one of TCO trim codes 206 associated with operational temperature 224 is selected from memory element 212 and is applied to raw sense voltage signal 134. In an embodiment, the negative of the selected one of TCO trim codes 206 is added to raw sense voltage signal 134 at a summing circuit 228 to produce compensated sense voltage signal 144. That is, TCO trim code 206, representing the offset error, is subtracted from raw sense voltage signal 134 to yield compensated sense voltage signal 144.

Offset error trim process 216 continues with a task 230. At task 230, compensated sense voltage signal 144, indicative of acceleration, and corrected for offset error is output from compensation circuit 170. Following task 230, an iteration of offset error trim process 216 ends. Of course, in some embodiments, process 216 may be continuously repeated in order to obtain continuous or periodic acceleration readings in accordance with particular design configurations.

Embodiments entail MEMS inertial sensor designs, which may be, for example, z-axis accelerometers or other sensing devices that incorporate built-in trim elements to produce trim capacitances in response to asymmetrical bending of the underlying substrate for use in offset trimming. That is, the trim elements are largely insensitive to acceleration (differentially) due to their symmetrical design. However, the trim elements are sensitive to asymmetrical bending of the underlying substrate to produce capacitance signals that will change differentially, thus serving as correction (trim) capacitors. Embodiments additionally entail methodology for utilizing the built-in trim elements and the resulting capacitances to perform a trim function using the measurements from the trim elements. The methodology can be used to perform dynamic, in situ compensation for the offset voltage or to determine TCO correction factors (trim code). Such an approach can yield test cost savings as well as improved sensor performance.

Although a particular MEMS device architecture is described in conjunction with the figures, embodiments may be implemented in MEMS devices having other architectures as well. Furthermore, certain process blocks described in connection with the methodology may be performed in parallel with each other or with performing other processes, and/or the particular ordering of the process blocks may be modified, while achieving substantially the same result. These and other such variations are intended to be included within the scope of the inventive subject matter.

While the principles of the inventive subject matter have been described above in connection with specific apparatus and methods, it is to be clearly understood that this description is made only by way of example and not as a limitation on the scope of the inventive subject matter. Further, the phraseology or terminology employed herein is for the purpose of description and not of limitation.

The foregoing description of specific embodiments reveals the general nature of the inventive subject matter sufficiently so that others can, by applying current knowledge, readily modify and/or adapt it for various applications without departing from the general concept. Therefore, such adaptations and modifications are within the meaning and range of equivalents of the disclosed embodiments. The inventive subject matter embraces all such alternatives, modifications, equivalents, and variations as fall within the spirit and broad scope of the appended claims.

What is claimed is:

1. An inertial sensor comprising:
a movable element coupled to a substrate, said movable element being adapted for motion about a rotational axis;
a first trim element; and
a second trim element, said first and second trim elements being spaced away from a surface of said substrate and positioned on opposing sides of said rotational axis, and said first and second trim elements being substantially immovable relative to said rotational axis.

2. An inertial sensor as claimed in claim 1 wherein said first and second trim elements are symmetrically disposed on opposing sides of said rotational axis.

3. An inertial sensor as claimed in claim 1 wherein said first and second trim elements are electrically isolated from said movable element.

4. An inertial sensor as claimed in claim 1 wherein said first and second trim elements are electrically connected to said movable element.

5. An inertial sensor as claimed in claim 1 further comprising:
a third trim element facing said first trim element, said third trim element being spaced away from said first trim element in a direction perpendicular to said surface of said substrate; and
a fourth trim element facing said second trim element, said fourth trim element being spaced away from said second trim element in said direction perpendicular to said surface of said substrate.

6. An inertial sensor as claimed in claim 5 wherein said direction is a first direction, said rotational axis is positioned between first and second ends of said movable element to form a first section between said rotational axis and said first end and a second section between said rotational axis and said second end, and said inertial sensor further comprises:
a first sense element facing said first section, said first sense element being spaced apart from said third trim element in a second direction parallel to said surface of said substrate; and
a second sense element facing said second section, said second sense element being spaced apart from said fourth trim element in said second direction parallel to said surface of said substrate.

7. An inertial sensor as claimed in claim 6 wherein said third and fourth trim elements are located closer to said rotational axis than said first and second sense elements.

8. An inertial sensor as claimed in claim 6 wherein said first and second sense elements are located closer to said rotational axis than said third and fourth trim elements.

9. An inertial sensor as claimed in claim 1 wherein said first trim element is configured to produce a first trim signal, said second trim element is configured to produce a second trim signal, and said inertial sensor further comprises:
a first sense element facing said movable element, wherein a first sense signal is produced between said movable element and said first sense element;
a second sense element facing said movable element, wherein a second sense signal is produced between said movable element and said second sense element; and
a compensation circuit adapted to apply said first and second trim signals to said first and second sense signals to trim an offset error in an output signal of said inertial sensor.

10. An inertial sensor as claimed in claim 1 wherein said first trim element is configured to produce a first trim signal, said second trim element is configured to produce a second trim signal, and said inertial sensor further comprises:
a first sense element facing said movable element, wherein a first sense signal is produced between said movable element and said first sense element;
a second sense element facing said movable element, wherein a second sense signal is produced between said movable element and said second sense element;
a temperature sensor for ascertaining an operational temperature at which said inertial sensor is operating; and
a compensation circuit adapted to apply a trim code to said first and second sense signals to compensate for an offset error in an output signal of said inertial sensor, said trim code being derived from said first and second trim signals, and said offset error resulting from said operational temperature.

11. An inertial sensor as claimed in claim 1 further comprising an anchor formed on said surface of said substrate, said movable element being movably coupled to said anchor, and said first and second trim elements being fixedly coupled to said anchor.

12. An inertial sensor as claimed in claim 11 further comprising a beam structure spaced away from said surface of said substrate, said beam structure having one end affixed to said first trim element, a second end affixed to said second trim element, and a central region affixed to said anchor.

13. An inertial sensor as claimed in claim 1 further comprising:
at least one first anchor formed on said surface of said substrate, said movable element being movably coupled to said at least one first anchor; and
a second anchor formed on said surface of said substrate, said first and second trim elements being fixedly coupled to said second anchor, said at least one first anchor and said second anchor being positioned at said rotational axis.

14. An inertial sensor comprising:
a movable element coupled to a substrate, said movable element being adapted for motion about a rotational axis;
a first trim element;
a second trim element, said first and second trim elements being spaced away from a surface of said substrate, said first and second trim elements being symmetrically disposed on opposing sides of said rotational axis;
a third trim element facing said first trim element, said third trim element being spaced away from said first trim element in a direction perpendicular to said surface of said substrate; and
a fourth trim element facing said second trim element, said fourth trim element being spaced away from said second trim element in said direction perpendicular to said surface of said substrate.

15. An inertial sensor as claimed in claim 14 wherein said direction is a first direction, said rotational axis is positioned between first and second ends of said movable element to form a first section between said rotational axis and said first end and a second section between said rotational axis and said second end, and said inertial sensor further comprises:
a first sense element facing said first section, said first sense element being spaced apart from said third trim element in a second direction parallel to said surface of said substrate; and
a second sense element facing said second section, said second sense element being spaced apart from said fourth trim element in said second direction parallel to said surface of said substrate.

16. An inertial sensor as claimed in claim 14 wherein a first trim signal is produced between said first and third trim elements, a second trim signal is produced between said second and fourth trim elements, and said inertial sensor further comprises:
a first sense element facing said movable element, wherein a first sense signal is produced between said movable element and said first sense element;
a second sense element facing said movable element, wherein a second sense signal is produced between said movable element and said second sense element; and
a compensation circuit adapted to apply said first and second trim signals to said first and second sense signals to trim an offset error in an output signal of said inertial sensor.

17. An inertial sensor as claimed in claim 1 wherein a first trim signal is produced between said first and third trim elements, a second trim signal is produced between said second and fourth trim elements, and said inertial sensor further comprises:
a first sense element facing said movable element, wherein a first sense signal is produced between said movable element and said first sense element;
a second sense element facing said movable element, wherein a second sense signal is produced between said movable element and said second sense element;
a temperature sensor for ascertaining an operational temperature at which said inertial sensor is operating; and
a compensation circuit adapted to apply a trim code to said first and second sense signals to compensate for an offset error in an output signal of said inertial sensor, said trim code being derived from said first and second trim signals, and said offset error resulting from said operational temperature.

18. A method of trimming an offset error in an inertial sensor, said inertial sensor including a movable element flexibly coupled to a substrate and adapted for motion about a rotational axis, and first and second trim elements suspended above a surface of said substrate and positioned on opposing sides of said rotational axis, and said method comprising:
receiving first and second trim signals, said first trim signal being produced between said first trim element and a third trim element facing said first trim element, said second trim signal being produced between said second trim element and a fourth trim element facing said second trim element;
applying said first and second trim signals to first and second sense signals to trim an offset error in an output signal of said inertial sensor, said first sense signal being produced between said movable element and a first sense element facing a first section of said movable element, said second sense signal being produced between said movable element and a second sense element facing a second section of said movable element, said first and second sections being located on opposing sides of said rotational axis.

19. A method as claimed in claim 18 further comprising:
concurrently receiving said first and second trim signals and said first and second sense signals; and
performing said applying operation as said first and second trim signals and said first and second sense signals are concurrently received to dynamically trim said offset error and produce said output signal.

20. A method as claimed in claim 18 further comprising:
exposing said inertial sensor to a plurality of temperature settings;
performing said receiving operation at each temperature setting of said plurality of temperature settings;
deriving a plurality of trim codes, one each of said trim codes of said plurality of trim codes being associated with one each of said temperature settings of said plurality of temperature settings;
ascertaining an operational temperature at which said inertial sensor is operating; and
selecting a first trim code from said plurality of trim codes in response to said operational temperature, wherein said applying operation applies said trim code to compensate for said offset error and produce said output signal, said offset error resulting from said operational temperature of said inertial sensor.
